(19) United States
(12) Patent Application Publication
(10) Pub. No.: US 2015/0138132 A1
(43) Pub. Date: May 21, 2015

(54) TOUCHSCREEN DEVICE AND METHOD OF SENSING TOUCH

(71) Applicant: SAMSUNG ELECTRO-MECHANICS CO., LTD., Suwon (KR)

(72) Inventor: Na Rae PARK, Suwon (KR)

(73) Assignee: SAMSUNG ELECTRO-MECHANICS CO., LTD., Suwon (KR)

(21) Appl. No.: 14/154,656

(22) Filed: Jan. 14, 2014

(30) Foreign Application Priority Data
Nov. 19, 2013 (KR) 10-2013-0140404

(51) Int. Cl. G06F 3/044

(52) U.S. Cl. CPC G06F 3/044
USPC 345/174

(57) ABSTRACT

There are provided a touchscreen device and a method of sensing a touch. The method of sensing a touch may include: acquiring sensing data from a panel unit; calculating valid data by obtaining a difference between the sensing data and an offset value; determining the number of anti-data items below a predetermined negative value among the valid data; and changing a predetermined positive threshold value for determining whether a touch has been made, if the amount of anti-data items is above a predetermined reference value.

### CROSS-REFERENCE TO RELATED APPLICATION

This application claims the benefit of Korean Patent Application No. 10-2013-0140404 filed on Nov. 19, 2013, with the Korean Intellectual Property Office, the disclosure of which is incorporated herein by reference.

### BACKGROUND

The present disclosure relates to a touchscreen device and a method of sensing a touch.

A touchscreen device such as a touchscreen or a touch pad, is a data input device attached to a display device so as to provide an intuitive user interface, and recently is being widely used in various electronic devices such as cellular phones, personal digital assistants (PDA), and navigation devices. Particularly, as the demand for smart phones has been recently increased, touchscreens have been increasingly employed as touchscreen devices able to provide various data input methods in a limited form factor.

Touchscreens used in portable devices may be mainly divided into a resistive type touchscreens and a capacitive type touchscreens, depending on the way in which a touch is sensed. Among these, the capacitive type touchscreen has advantages of a relatively long lifespan and ease of implementing various input manners and gestures, and thus it has been increasingly employed in devices. In particular, such a capacitive type touchscreen allows for the implementation of a multi-touch interface as compared to the resistive type touchscreen, and thus, it is widely used in smart phones and the like.

The capacitive type touchscreen includes a plurality of electrodes having a predetermined pattern and the electrodes define a plurality of nodes in which changes in capacitance due to touches are generated. Nodes arrayed on a two-dimensional plane generate changes in self-capacitance or mutual-capacitance by a touch. Coordinates of the touch may be calculated by applying a weighted average method or the like to the changes in capacitance generated in the nodes.

The touchscreen device determines that a touch has been made if sensing data above a predetermined threshold value is present among the acquired sensing data items. If an object such as a coin comes in contact with the touchscreen and is then removed therefrom, an afterimage, i.e., a ghost touch, may remain, so that a valid touch having been made may be erroneously determined.

### RELATED ART DOCUMENT

(Patent Document 1) Korean Patent Laid-Open Publication No. 2008-0013638

### SUMMARY

An aspect of the present disclosure may provide a touchscreen device and a method of sensing a touch in which a positive threshold value for determining whether a touch has been made may be changed based on the number of anti-data items below a predetermined negative threshold value among valid data obtained by subtracting an offset value from sensing data.

According to an aspect of the present disclosure, a method of sensing a touch may include: acquiring sensing data from a panel unit; calculating valid data by obtaining a difference between the sensing data and an offset value; determining the number of anti-data items below a predetermined negative value among the valid data; and changing a predetermined positive threshold value for determining whether a touch has been made, if the amount of anti-data items is above a predetermined reference value.

The changing of the predetermined positive threshold value may include changing the predetermined positive threshold value by the amount greater than a maximum value of absolute values of the anti-data items above the reference value.

An absolute value of the predetermined positive threshold value may be equal to that of the predetermined negative threshold value.

The method may further include: updating the offset value with the valid data if there is no valid data above the changed threshold value.

The method may further include: maintaining the positive threshold value if the amount of anti-data items is below the reference value.

The method may further include: maintaining the offset value if there is a valid data value above the maintained positive threshold value.

If there is a valid data value above the maintained threshold value, at least one of the number of touches, coordinates of the touches, and the type of gesture of the touches may be determined based on the valid data.

According to another aspect of the present disclosure, a touchscreen device may include: a panel unit including a plurality of first electrodes, and a plurality of second electrodes insulated from the plurality of first electrodes; a sensing circuit unit detecting capacitance from the plurality of second electrodes; a signal conversion unit converting an analog signal output from the sensing circuit unit into a digital signal so as to generate sensing data; and an operation unit calculating valid data by obtaining a difference between the sensing data and an offset value so as to determine a touch based on the number of anti-data items below a predetermined negative threshold value among the valid data.

The operation unit may change a positive predetermined threshold value for determining whether a touch has been made, if the amount of anti-data items is above a predetermined reference value.

The operation unit may change the positive threshold value by the amount greater than a maximum value of absolute values of the anti-data items above the reference value, if the number of anti-data items is above the reference value.

An absolute value of the predetermined positive threshold value may be equal to that of the predetermined negative threshold value.

The operation unit may update the offset value with the valid data, if there is no valid data above the changed positive threshold value.

The operation unit may maintain the positive threshold value if the amount of anti-data items is below the reference value.

The operation unit may maintain the offset value if there is a valid data value above the maintained positive threshold value.

The operation unit may determine at least one of the number of touches, coordinates of the touches, and the type of gesture of the touches.

The touchscreen device may further include a driving circuit unit applying driving signals to the plurality of first electrodes.

The capacitance may be generated between an intersection of the plurality of first electrodes and the plurality of second electrodes.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating an appearance of an electronic device including a touchscreen device according to an exemplary embodiment of the present disclosure;

FIG. 2 is a view of a panel unit included in a touchscreen device according to an exemplary embodiment of the present disclosure;

FIG. 3 is a cross-sectional view of a panel unit included in a touchscreen device according to an exemplary embodiment of the present disclosure;

FIG. 4 is a diagram illustrating a touchscreen device according to an exemplary embodiment of the present disclosure;

FIG. 5 is a flowchart illustrating a method of sensing a touch according to an exemplary embodiment of the present disclosure; and

FIG. 6 is a set of graphs illustrating the operation of a touch sensing device according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

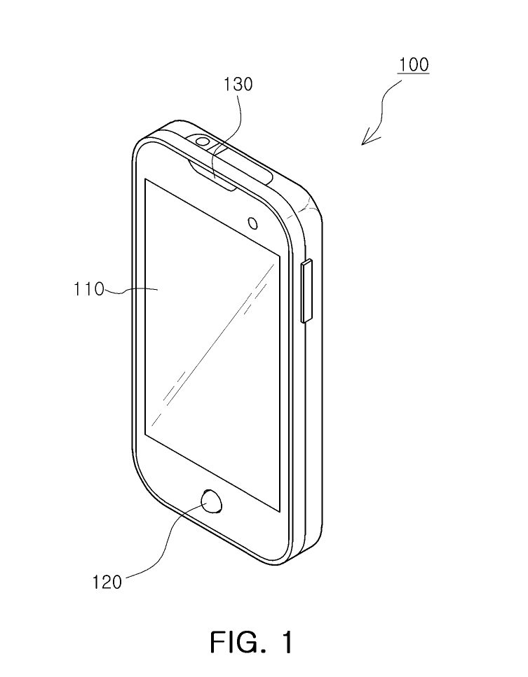

FIG. 1 is a perspective view illustrating an appearance of an electronic device including a touchscreen device according to an exemplary embodiment of the present disclosure.

Referring to FIG. 1, the electronic device 100 according to the present embodiment may include a display device 110 outputting images on a screen, an input unit 120, an audio unit 130 outputting sound, and a touch sensing device integrated with the display device 110.

As shown in FIG. 1, typically in mobile devices, the touch sensing device is integrated with the display device, and should have an amount of light transmissivity sufficient to allow images on the display to be seen therethrough. Therefore, the touch sensing device may be implemented by forming a sensing electrode using a transparent and electrically conductive material such as indium tin oxide (ITO), indium zinc oxide (IZO), zinc oxide (ZnO), carbon nanotubes (CNT), or graphene on a base substrate formed of a transparent film material such as polyethylene terephthalate (PET), polycarbonate (PC), polyethersulfone (PES), polyimide (PI), polymethylmethacrylate (PMMA), or the like. The display device may include a wiring pattern disposed in a bezel region thereof, in which the wiring pattern is connected to the sensing electrode formed of the transparent and conductive material. Since the wiring pattern is hidden by the bezel region, it may be formed of a metal such as silver (Ag) or copper (Cu).

Since it is assumed that the touch sensing device according to the exemplary embodiment of the present disclosure is operated in a capacitive manner, the touchscreen device may include a plurality of electrodes having a predetermined pattern. Further, the touchscreen device may include a capacitance sensing circuit to sense changes in the capacitance generated in the plurality of electrodes, an analog-digital converting circuit to convert an output signal from the capacitance sensing circuit into a digital value, and a calculating circuit to determine if a touch has been made using the converted digital value.

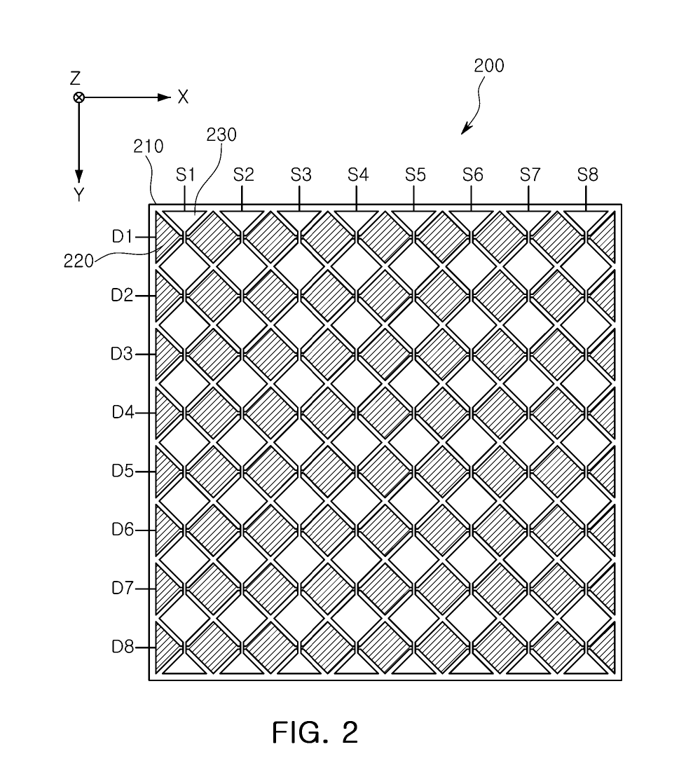

FIG. 2 is a view of a panel unit included in a touchscreen device according to an exemplary embodiment of the present disclosure.

Referring to FIG. 2, the panel part 200 according to the exemplary embodiment includes a substrate 210 and a plurality of electrodes 220 and 230 provided on the substrate 210. Although not shown in FIG. 2, each of the plurality of electrodes 220 and 230 may be electrically connected to a wiring pattern on a circuit board attached to one end of the substrate 210 through a wiring and a bonding pad. The circuit board may have a controller integrated circuit mounted thereon so as to detect a sensing signal generated in the plurality of electrodes 220 and 230, and may determine a touch based on the detected sensing signal.

The plurality of electrodes 220 and 230 may be formed on one surface or both surfaces of the substrate 210. Although the plurality of electrodes 220 and 230 are shown to have a lozenge- or diamond-shaped pattern in FIG. 2, it is apparent that the plurality of electrodes 220 and 230 may have a variety of polygonal shapes such as rectangular and triangular shapes.

The plurality of electrodes 220 and 230 may include first electrodes 220 extending in the x-axial direction, and second electrodes 230 extending in the y-axial direction. The first electrodes 220 and the second electrodes 230 may be provided on both surfaces of the substrate 210 or may be provided on different substrates 210 such that they may intersect with each other. When all of the first electrodes 220 and the second electrodes 230 are provided on one surface of the substrate 210, a predetermined insulating layer may be partially formed at points of intersection between the first electrodes 220 and the second electrodes 230.

In addition to the region on which the plurality of electrodes 220 and 230 are formed, the substrate 210 may have a printed region formed thereon, which includes wirings connecting the plurality of electrodes 220 and 230 and hides the wirings typically made of an opaque metal.

A device, electrically connected to the plurality of electrodes 220 and 230 to sense a touch, detects changes in capacitance generated in the plurality of electrodes 220 and 230 resulting from a touch to sense the touch based on the detected change in capacitance. The first electrodes 220 may be connected to channels defined as D1 to D8 in the controller integrated circuit to receive predetermined driving signals, and the second electrodes 230 may be connected to channels defined as S1 to S8 to be used by the touch sensing device to detect a sensing signal. Here, the controller integrated circuit may detect changes in mutual-capacitance generated between the first and second electrodes 220 and 230 as the sensing signal, in a such manner that the driving signals are sequentially applied to the first electrodes 220 and changes in capacitance are simultaneously detected from the second electrodes 220.

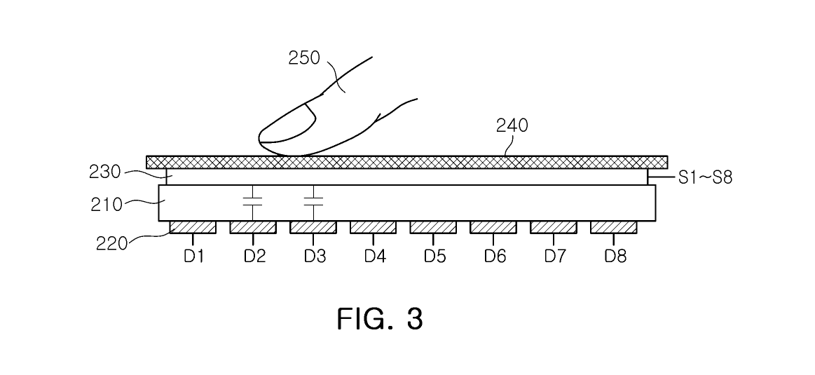

FIG. 3 is a cross-sectional view of a panel unit included in a touchscreen device according to an exemplary embodiment of the present disclosure. FIG. 3 is a cross-sectional view of the panel unit 200 illustrated in FIG. 2 taken on the y-z plane, in which the panel unit 200 may further includes a cover lens 240 that is touched, in addition to the substrate 210, and the plurality of sensing electrodes 220 and 230 described above. The cover lens 240 is provided on the second electrodes 230 used in detecting sensing signals, to receive a touch from a touching object 250 such as a finger.

When driving signals are sequentially applied to the first electrodes 320 through the channels D1 to D8, mutual-capacitance is generated between the first electrodes 220, to which the driving signals are applied, and the second electrodes 230. When the driving signals are sequentially applied to the first electrodes 220, changes in mutual-capacitance may occur between the first electrode 220 and the second electrode 230 close to the region with which the touching object 250 comes in contact. The change in the mutual-capacitance may be proportional to the overlapped area between the region that the touching object 250 comes into contact with, the region of the first electrodes 220, to which the driving signals are applied, and the second electrodes 230. In FIG. 3, the mutual-capacitance generated between the first electrodes 220 connected to channel D2 and D3, respectively, and the second electrodes 230 is influenced by the touching object 250.

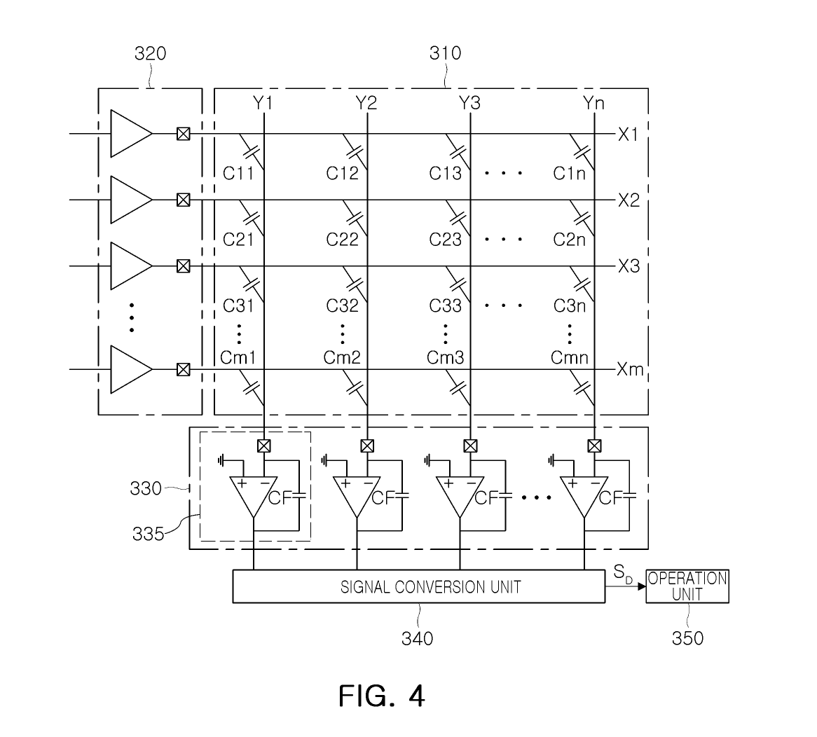

FIG. 4 is a diagram illustrating a touchscreen device according to an exemplary embodiment of the present disclosure.

Referring to FIG. 4, the touchscreen device according to the exemplary embodiment may include a panel unit 310, a driving circuit unit 320, a sensing circuit unit 330, a signal conversion unit 340, and an operation unit 350. The driving circuit unit 320, the sensing circuit unit 330, the signal conversion unit 340, and the operation unit 350 may be implemented as a single integrated circuit (IC).

The panel unit 310 may include rows of first electrodes X1 to Xm extending in a first axial direction (that is, the horizontal direction of FIG. 4), and columns of second electrodes Y1 to Yn extending in a second axial direction (that is, the vertical direction of FIG. 4) crossing the first axial direction. Node capacitors C11 to Cmn are the equivalent representation of mutual capacitance generated at intersections of the first electrodes X1 to Xm and the second electrodes Y1 to Yn

The driving circuit unit 320 may apply predetermined driving signals to the first electrodes X1 to Xm of the panel unit 310. The driving signals may be square wave signals, sine wave signals, triangle wave signals or the like having a specific frequency and an amplitude and may be sequentially applied to the plurality of first electrodes. Although FIG. 4 illustrates that circuits for generating and applying the driving signals are individually connected to the plurality of first electrodes, it is apparent that a single driving signal generating circuit may be used to apply the driving signals to the plurality of first electrodes by employing a switching circuit. In addition, the driving circuit unit 320 may apply driving signals to all of the first electrodes simultaneously or to only some of the first electrodes selectively, to simply determine whether a touch has been made.

The sensing circuit unit 330 may detect capacitance of the node capacitors C11 to Cmn from the second electrodes Y1 to Yn. The sensing circuit unit 330 may include C-V converters 335, each of which has at least one operation amplifier and at least one capacitor and is connected to the respective second electrodes Y1 to Yn.

The C-V converters 335 may convert the capacitance of the node capacitors C11 to Cmn into voltage signals so as to output analog signals. For example, each of the C-V converters 335 may include an integration circuit to integrate capacitance values. The integration circuit may integrate and convert capacitance values into a voltage value to be output.

Although each of the C-V converter 335 shown in FIG. 4 has the configuration in which a capacitor CF is disposed between the inverted input and the output of an operation amplifier, it is apparent that the circuit configuration may be altered. Moreover, while each C-V converter 335 shown in FIG. 4 has one operational amplifier and one capacitor, each C-V converter 335 may have a number of operational amplifiers and capacitors.

When driving signals are applied to the first electrodes X1 to Xm sequentially, capacitance may be detected simultaneously from the second electrodes, the number of required C-V converts 335 is equal to the amount of second electrodes Y1 to Yn, i.e., n.

The signal conversion unit 340 may generate digital signal S_{D} from the analog signals output from the sensing circuit unit 330. For example, the signal converting unit 340 may include a time-to-digital converter (TDC) circuit measuring a time taken for the analog signals in the form of voltage output from the sensing circuit unit 330 to reach a predetermined reference voltage level to convert the measured time into the digital signal S_{D}, or an analog-to-digital converter (ADC) circuit measuring amounts of changes in levels of the analog signals output from the sensing circuit unit 330 for a predetermined time to convert the changed amount into the digital signal S_{D}.

The operation unit 350 may determine whether a touch occurs on the panel unit 310 using the digital signal S_{D}. The operation unit 350 may determine the number of touches, coordinates of the touches, and the types of gesture of the touches or the like made on the panel unit 310, based on the digital signal S_{D}.

The digital signal S_{D}, used by the operation unit 350 to determine whether a touch input has been made, may be data that is a numerical value representing changes in capacitance of the capacitors C11 to Cmn, especially representing a difference between the capacitance with and without a touch input. Typically, in a capacitive type touchscreen device, a region in which a conductive object comes into contact with has less capacitance than regions with which no conductive object comes into contact.

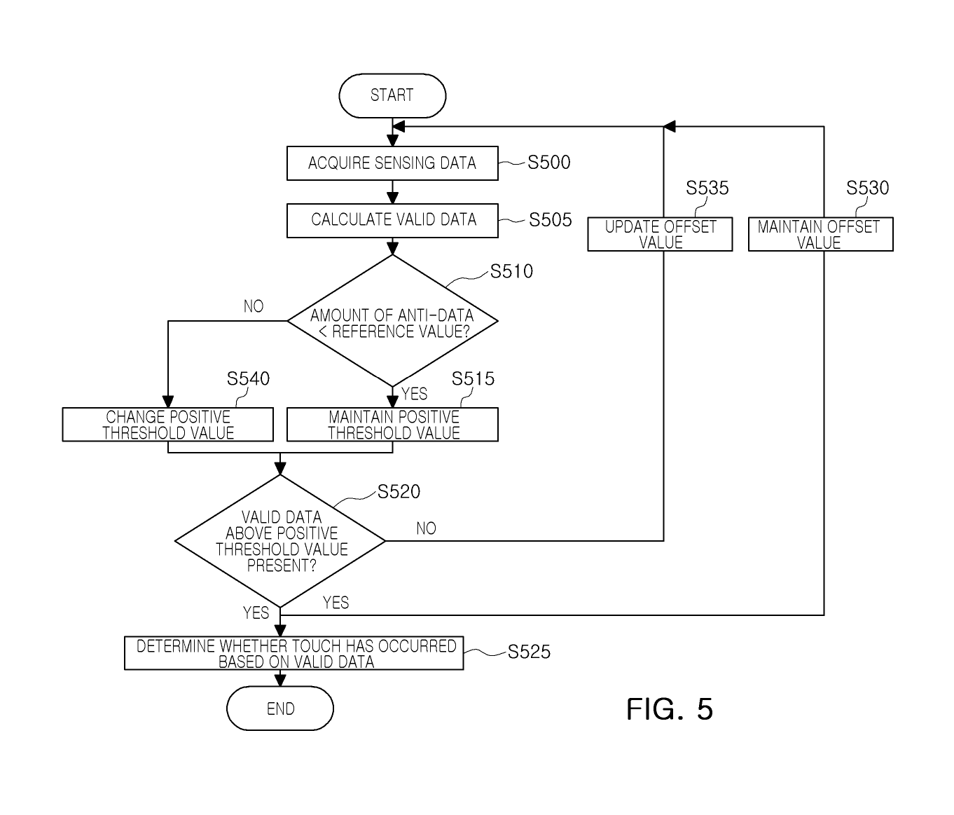

FIG. 5 is a flowchart illustrating a method of sensing a touch input according to an exemplary embodiment of the present disclosure.

Referring to FIGS. 4 and 5, the method of sensing a touch input according to the exemplary embodiment may start with acquiring sensing data (S500). The driving circuit unit 320 may apply driving signals to the plurality of first electrodes to acquire sensing data. The sensing circuit unit 330 may detect changes in capacitance from the second electrodes intersecting the first electrodes to which the driving signals are applied. The sensing circuit unit 330 may detect changes in capacitance as an analog signal using the integration circuit, and the analog signal output from the sensing circuit unit 330 may be converted into a digital signal S_{D} by the signal conversion unit 340. The operation unit 350 may determine whether a touch input has been made using the digital signal S_{D} as sensing data. Upon acquiring the sensing data, the operation unit 350 may subtract an offset value from the sensing data to calculate valid data (S505). The offset value may be determined from valid data calculated when no touch input has been made.

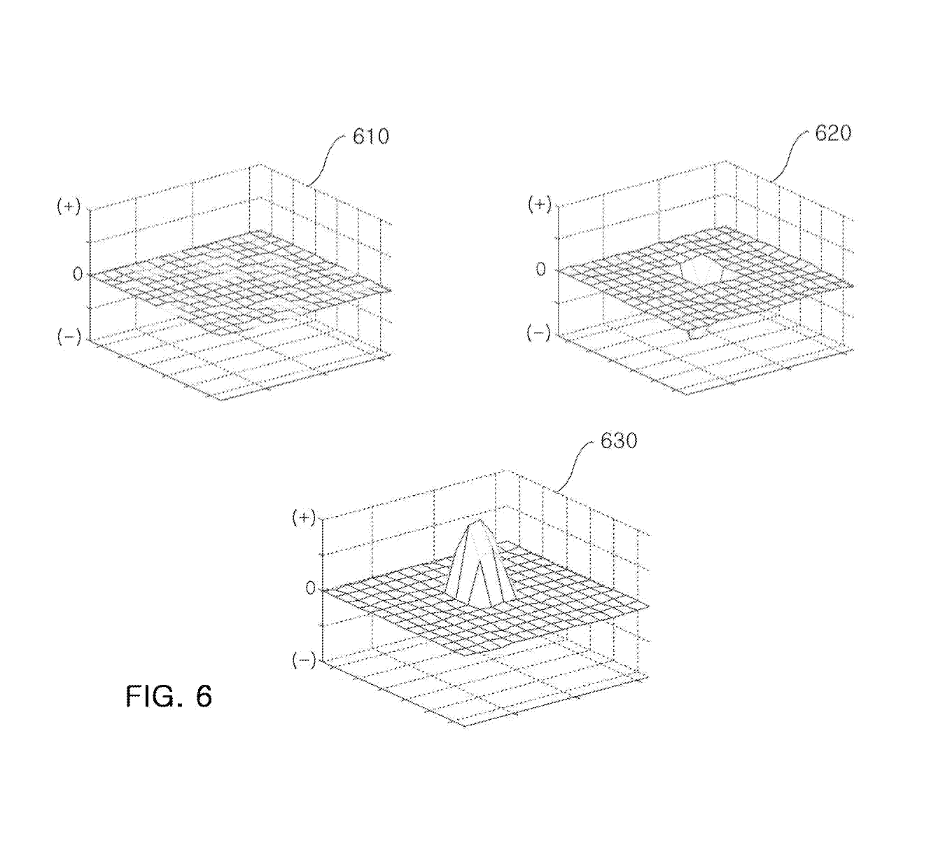

FIG. 6 is a set of graphs illustrating the operation of a touch sensing device according to an exemplary embodiment of the present disclosure.

Referring to FIG. 6, three graphs are shown. The first graph 610 shows sensing data when no user touch has been made. The data shown in the first graph 610 may be set as an offset value.

The second graph 620 shows sensing data that is acquired when a user touch has been made. As described above, if a conductive object such as a finger comes in contact with the panel unit 310, capacitance moves to the conductive object and in turn the data value is reduced around a region where the conductive object is in contact, such that sensing data is acquired.

The third graph 630 shows valid data that is calculated by subtracting the second graph 620, i.e., the sensing data, from the first graph 610, i.e., the offset value. The operation unit 350 may determine that a touch has been made if there is a valid data value above a predetermined positive threshold value.

If a valid touch has been made on the panel unit 510 such as when a finger or a stylus pen comes in contact therewith, valid data values distributing in the positive (+) region are acquired as shown in the third graphs 630 in FIG. 6. On the contrary, if an object such as a coin is placed on the panel unit 510, a majority of valid data values are distributed in the negative (−) region. Valid data values distributed in the negative (−) region do not cause problems if a negative threshold value is exceeded thereby. However, if the valid data is below the negative threshold value, a problem such as a “ghost touch” may arise when an object such as a coin is removed after the negative valid data is updated with an offset value. Here, the absolute value of the positive (+) threshold value may be equal to that of the negative (−) threshold value.

In order to prevent a “ghost touch,” the operation unit 350 calculates valid data to determine the number of anti-data items included in the valid data (S510). The anti-data refers to data below a predetermined negative (−) threshold value. If the number of anti-data items is below a reference value, it is determined that the anti-data occurs due to LCD noise or the like so that the threshold value is maintained (S515), and then it is determined if there is a valid data value above the positive (+) threshold value (S520).

If there is a valid data value above the positive (+) threshold value, it is determined that a valid touch has been made, and accordingly the operation unit 350 determines the number of touches, coordinates of the touches, and the type of gesture of the touches or the like, based on the valid data (S525). Here, the offset value may be kept at the offset value of the previous frame (S530).

On the contrary, if there is no valid data value above the positive (+) threshold value, it is determined that no valid touch has been made, and accordingly the operation unit 350 updates the offset value with valid data acquired from circumferential operational conditions in the current frame (S535).

If it is determined, in the determining S510, that the number of anti-data items included in the valid data is above the reference value, the operation unit 350 determines that this change is caused by an invalid touch such as a coin and accordingly changes the predetermined positive (+) threshold value (S540). The positive (+) threshold value to be changed may be greater than the maximum value of the absolute values of a plurality of anti-data items above the reference value.

Then, it is determined if there is a valid data value above the changed threshold value in determining S520 in the same manner. If an object such as a coin comes in contact, there is no valid data above the changed threshold value, and accordingly the operation unit 350 updates the offset value with the calculated valid data (S535).

As such, if an invalid touch has been made, a positive (+) threshold value for determining whether a touch has been made is changed to be greater than absolute values of a plurality of anti-data items, such that a “ghost touch” may be prevented even if an object such as a coin is removed after valid data is updated with an offset value.

As set forth above, according to exemplary embodiments of the present disclosure, a “ghost touch” occurring when an object such as a coin comes in contact with a touchscreen may be prevented by way of changing a positive threshold value for determining whether a touch has been made, based on the number of anti-data items below a predetermined negative threshold value among valid data obtained by subtracting an offset value from sensing data.

While exemplary embodiments have been shown and described above, it will be apparent to those skilled in the art that modifications and variations could be made without departing from the spirit and scope of the present disclosure as defined by the appended claims.

What is claimed is:

1. A method of sensing a touch, comprising:
acquiring sensing data from a panel unit;
calculating valid data by obtaining a difference between the sensing data and an offset value;
determining the number of anti-data items below a predetermined negative value among the valid data; and
changing a predetermined positive threshold value for determining whether a touch has been made, if the amount of anti-data items is above a predetermined reference value.

2. The method of claim 1, wherein the changing of the predetermined positive threshold value includes changing the predetermined positive threshold value by the amount greater than a maximum value of absolute values of the anti-data items above the reference value.

3. The method of claim 1, wherein an absolute value of the predetermined positive threshold value is equal to that of the predetermined negative threshold value.

4. The method of claim 1, further comprising:
updating the offset value with the valid data if there is no valid data above the changed threshold value.

5. The method of claim 1, further comprising:
maintaining the positive threshold value if the amount of anti-data items is below the reference value.

6. The method of claim 5, further comprising:
maintaining the offset value if there is a valid data value above the maintained positive threshold value.

7. The method of claim 5, wherein, if there is a valid data value above the maintained threshold value, at least one of the number of touches, coordinates of the touches, and the type of gesture of the touches is determined based on the valid data.

8. A touchscreen device, comprising:
a panel unit including a plurality of first electrodes, and a plurality of second electrodes insulated from the plurality of first electrodes;
a sensing circuit unit detecting capacitance from the plurality of second electrodes;
a signal conversion unit converting an analog signal output from the sensing circuit unit into a digital signal so as to generate sensing data; and
an operation unit calculating valid data by obtaining a difference between the sensing data and an offset value so as to determine a touch based on the number of anti-data items below a predetermined negative threshold value among the valid data.

9. The touchscreen device of claim 8, wherein the operation unit changes a positive predetermined threshold value for determining whether a touch has been made, if the amount of anti-data items is above a predetermined reference value.

10. The touchscreen device of claim 9, wherein the operation unit changes the positive threshold value by the amount greater than a maximum value of absolute values of the anti-data items above the reference value, if the number of anti-data items is above the reference value.

11. The touchscreen device of claim 9, wherein an absolute value of the predetermined positive threshold value is equal to that of the predetermined negative threshold value.

12. The touchscreen device of claim 9, wherein the operation unit updates the offset value with the valid data, if there is no valid data above the changed positive threshold value.

13. The touchscreen device of claim 8, wherein the operation unit maintains the positive threshold value, if the amount of anti-data items is below the reference value.

14. The touchscreen device of claim 13, wherein the operation unit maintains the offset value, if there is a valid data value above the maintained positive threshold value.

15. The touchscreen device of claim 8, wherein the operation unit determines at least one of the number of touches, coordinates of the touches, and the type of gesture of the touches.

16. The touchscreen device of claim 8, further comprising:
a driving circuit unit applying driving signals to the plurality of first electrodes.

17. The touchscreen device of claim 8, wherein the capacitance is generated between an intersection of the plurality of first electrodes and the plurality of second electrodes.
